(19) United States
(12) Patent Application Publication
(10) Pub. No.: US 2022/0319308 A1
(43) Pub. Date: Oct. 6, 2022

(54) SMART TRAFFIC ASSISTANT SYSTEMS AND METHODS

(71) Applicant: Honda Motor Co., Ltd., Tokyo (JP)

(72) Inventor: Soroush JALALI, Ann Arbor, MI (US)

(21) Appl. No.: 17/218,519

(22) Filed: Mar. 31, 2021

(51) Int. Cl. G08G 1/01; B60W 60/00

(52) U.S. Cl. CPC G08G 1/0133; G08G 1/0116; G08G 1/0145; B60W 60/001

(57) ABSTRACT

Systems and methods for assisting road agents includes connected devices and a processor operably connected for computer communication to the connected devices. The connected devices are devices in proximity to a traffic junction and capture sensor data about the road agents and the traffic junction. The processor is configured to receive an invocation input including a desired action to be executed at the traffic junction. The processor is also configured to manage interactions between the road agents to coordinate execution of the desired action by converting human-readable medium to vehicle-readable medium in a back-and-forth manner. Further, the processor is configured to receive a cooperation acceptance input from the second road agent indicating an acceptance to coordinate execution of the desired action or a non-acceptance to coordinate execution of the desired action, and transmit a response output invoking the desired action based on the cooperation acceptance input.

### BACKGROUND

Drivers and pedestrians can communicate using non-verbal methods to negotiate safe passage, for example, at a traffic junction having a pedestrian crossing. However, it can be difficult to accurately understand non-verbal communication from both pedestrians and drivers. Additionally, pedestrians lack a reliable and accurate way to interact with autonomous vehicles (AV) or swarms of cooperative vehicles. Pedestrians can be unaware that a lack of communication has occurred despite road user detection and classification. This contributes to the fear of pedestrians towards AV and impedes trust which is one of the major hurdles in mass adoption. Reliable pedestrian assistance to safely interact with vehicles at a traffic junction will improve pedestrian and traffic flow as well as increase trust and certainty in AV and swarms of cooperative vehicles.

### BRIEF DESCRIPTION

According to one aspect, a system for assisting road agents including a first road agent and a second road agent includes connected devices and a processor operably connected for computer communication to the connected devices. The connected devices are devices in proximity to a traffic junction and capture sensor data about the road agents and the traffic junction. The processor is configured to receive an invocation input including a desired action to be executed at the traffic junction. The processor is also configured to manage interactions between the road agents to coordinate execution of the desired action by converting human-readable medium to vehicle-readable medium in a back-and-forth manner. Further, the processor is configured to receive a cooperation acceptance input from the second road agent indicating an acceptance to coordinate execution of the desired action or a non-acceptance to coordinate execution of the desired action, and transmit a response output invoking the desired action based on the cooperation acceptance input.

According to another aspect, a computer-implemented method for assisting road agents at a traffic junction, where the road agents include at least a first road agent and a second road agent, includes receiving sensor data from one or more connected devices in proximity to the traffic junction. The sensor data includes an invocation input with a desired action to be executed at the traffic junction by the first road agent. The method includes managing interactions between the first road agent and the second road agent based on the sensor data and the desired action including converting interactions from human-readable medium to machine-readable medium and vice versa. The method also includes receiving a cooperation acceptance input from the second road agent indicating an agreement to execute a cooperation action thereby allowing execution of the desired action by the first road agent. Furthermore, the method includes transmitting a response output to the one or more connected devices, wherein the response output includes instructions to invoke the desired action.

According to a further aspect, a non-transitory computer-readable medium comprising computer-executable program instructions, when executed by one or more processors, the computer-executable program instructions configures the one or more processors to perform operations including receiving an invocation input including a desired action to be executed by a first road agent at a traffic junction. The operations also include receiving sensor data associated with the invocation input and the desired action, and translating human-readable medium to vehicle-readable medium in a back-and-forth manner between the first road agent and a second road agent to coordinate execution of the desired action. The operations also include receiving a cooperation acceptance input from the second road agent indicating an acceptable to coordinate execution of the desired action or a non-acceptance to coordinate execution of the desired action. Further, the operations include transmitting a response output invoking the desired action based on the cooperation acceptance input.

### BRIEF DESCRIPTION OF THE DRAWINGS

The accompanying drawings, which are incorporated in and constitute a part of the specification, illustrate various systems, methods, devices, and other embodiments of the disclosure. It will be appreciated that the illustrated element boundaries (e.g., boxes, groups of boxes, directional lines, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 is a schematic diagram of an exemplary traffic scenario including a traffic junction according to one embodiment;

FIG. 2 is a block diagram of an exemplary smart traffic assistant system for according to one embodiment;

FIG. 3 is a block diagram illustrating exemplary processing of input data by a conversation interface according to one embodiment;

FIG. 4A is an exemplary smart traffic assistant method according to one embodiment;

FIG. 4B is a functional flow diagram of the method shown in FIG. 4A according to one exemplary embodiment;

FIG. 5A illustrates an exemplary implementation of smart traffic assistant systems and methods at the traffic junction of FIG. 1 according to an exemplary embodiment;

FIG. 5B illustrates the exemplary implementation of smart traffic assistant systems and methods at the traffic junction of FIG. 1 shown in FIG. 5A, but after processing a voice utterance according to an exemplary embodiment;

FIG. 6A illustrates another exemplary implementation of smart traffic assistant systems and methods at the traffic junction of FIG. 1; and

FIG. 6B illustrates the exemplary implementation of smart traffic assistant systems and methods shown in FIG. 6A, but during execution of the desired action at the traffic junction of FIG. 1.

### DETAILED DESCRIPTION

The following includes definitions of selected terms employed herein. The definitions include various examples and/or forms of components that fall within the scope of a term and that may be used for implementation. The examples are not intended to be limiting. Further, the components discussed herein, may be combined, omitted or organized with other components or into different architectures.

“Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication,” as used herein, refers to a communication between two or more computing devices (e.g., computer, personal digital assistant, cellular telephone, network device, vehicle, vehicle computing device, infrastructure device, roadside device) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless area network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Computer-readable medium,” as used herein, refers to a non-transitory medium that stores instructions, algorithms, and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Computer-readable medium can include, but is not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can interface with. Computer-readable medium excludes non-transitory tangible media and propagated data signals.

“Database,” as used herein, is used to refer to a table. In other examples, “database” may be used to refer to a set of tables. In still other examples, “database” may refer to a set of data stores and methods for accessing and/or manipulating those data stores. A database may be stored, for example, at a disk and/or a memory.

“Disk,” as used herein may be, for example, a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM). The disk may store an operating system that controls or allocates resources of a computing device.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry may include and/or be a part of a processor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Operable connection,” or a connection by which entities are “operably connected,” is one in which signals, physical communications, and/or logical communications may be sent and/or received. An operable connection may include a wireless interface, a physical interface, a data interface, and/or an electrical interface.

“Portable device,” as used herein, is a computing device typically having a display screen with user input (e.g., touch, keyboard) and a processor for computing. Portable devices include, but are not limited to, handheld devices, mobile devices, smart phones, laptops, tablets and e-readers.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms.

“Vehicle,” as used herein, refers to any moving vehicle that is capable of carrying one or more human occupants and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” may refer to an electric vehicle (EV) that is capable of carrying one or more human occupants and is powered entirely or partially by one or more electric motors powered by an electric battery. The EV may include battery electric vehicles (BEV) and plug-in hybrid electric vehicles (PHEV). The term “vehicle” may also refer to an autonomous vehicle and/or self-driving vehicle powered by any form of energy. The autonomous vehicle may carry one or more human occupants. The autonomous vehicle can have any level or mode of driving automation ranging from, for example, fully manual to fully autonomous. Further, the term “vehicle” may include vehicles that are automated or non-automated with pre-determined paths or free-moving vehicles.

“Vehicle control system,” and/or “vehicle system,” as used herein may include, but is not limited to, any automatic or manual systems that may be used to enhance the vehicle, driving, and/or security. Exemplary vehicle systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pre-tensioning system, a monitoring system, a passenger detection system, a vehicle suspension system, a vehicle seat configuration system, a vehicle cabin lighting system, an audio system, a sensory system, an interior or exterior camera system among others.

### I. System Overview

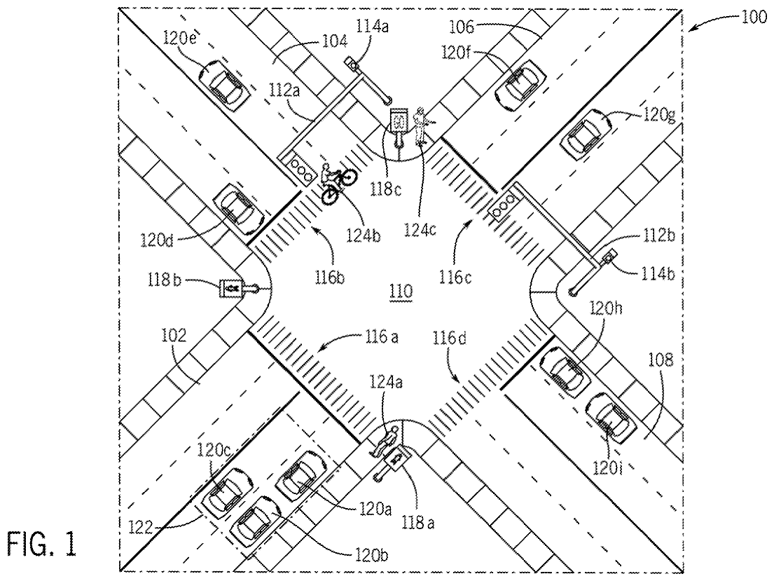

The systems and methods discussed herein facilitate communication between pedestrians, vehicles, and traffic infrastructures to negotiate and execute actions thereby resolving traffic scenarios (e.g., pedestrian crossings at a traffic junction). More specifically, a smart traffic assistant is employed for interacting and managing communication between the pedestrians, vehicles, and infrastructures thereby controlling traffic actions and traffic flow. Referring now to the drawings, wherein the showings are for purposes of illustrating one or more exemplary embodiments and not for purposes of limiting same, FIG. 1 illustrates an exemplary traffic scenario 100 where the methods and systems described herein can take place. The traffic scenario 100 includes a first road segment 102, a second road segment 104, a third road segment 106, and a fourth road segment 108, which each meet at a traffic junction 110 (e.g., an intersection). As shown in FIG. 1, each road segment has two lanes, which run in opposite directions of traffic flow. In some embodiments, the traffic junction 110 can be a roundabout or other type of traffic flow structure. It is understood that any number of roads, lanes, and intersections other than that shown in FIG. 1 can be implemented with the methods and system discussed herein.

In FIG. 1, the traffic junction 110 is a controlled intersection regulated by a traffic signal device 112a and a traffic signal device 112b. The traffic intersection also includes a camera 114a and a camera 114b. In some embodiments, the camera 114a and/or the camera 114b are sensors and/or connected devices for capturing sensor data about the traffic junction 110.

The traffic junction 110 also includes a crosswalk 116a, a crosswalk 116b, a crosswalk 116c, and a crosswalk 116d. The crosswalks 116 can be controlled or uncontrolled, for example, by a signal and/or a regulatory sign. For example, crossing the first road segment 102 via the crosswalk 116a can be controlled by a crosswalk signal device 118a and/or a crosswalk signal device 118b. Crossing the second road segment 104 via the crosswalk 116b can be controlled by the crosswalk signal device 118b and/or the crosswalk signal device 118c. In contrast, in FIG. 1 crossing the third road segment 106 via the crosswalk 116c and/or crossing the fourth road segment 108 via the crosswalk 116d is uncontrolled. As will be discussed herein in more detail, the traffic signal device 112a, the traffic signal device 112b, the camera 114a, and the camera 114b, the crosswalk signal device 118a, the crosswalk signal device 118b, and the crosswalk signal device 118c can also each be referred to as a connected device that is part of a communication network (e.g., vehicle-to-everything (V2X) communication).

As mentioned above, the systems and methods describe herein assist communication between vehicles 120 and pedestrians 124. In FIG. 1, a vehicle 120a, a vehicle 120b, and a vehicle 120c are shown on the first road segment 102, a vehicle 120d and a vehicle 120e are shown on the second road segment 104, a vehicle 120f and a vehicle 120g are shown on the third road segment 106, and a vehicle 120h and a vehicle 120i are shown on the fourth road segment 108. In some embodiments, one or more of the vehicles 120 can operate as a coordinated swarm (e.g., a platoon, a convoy, a formation). For example, the vehicle 120a, the vehicle 120b, and the vehicle 120c can be part of a coordinated swarm 122 (e.g., a platoon).

One or more of the pedestrians 124 can desire to cross one or more road segments shown in FIG. 1. For example, a pedestrian 124a can desire to cross the first road segment 102, a pedestrian 126b (i.e., a cyclist) is shown crossing the second road segment 104, and a pedestrian 124c can desire to cross the third road segment 106. In the embodiments described herein, the vehicles 120 and/or the pedestrians 124 can be referred to as road agents, a first road agent, and/or a second road agent. As used herein, road agents can include pedestrians, vehicles, cyclists, or any other road user utilizing the road segments and/or adjacent road structures (e.g., sidewalks). The elements of FIG. 1 will be used throughout this description to illustrate exemplary embodiments implementing smart traffic assistant systems and methods.

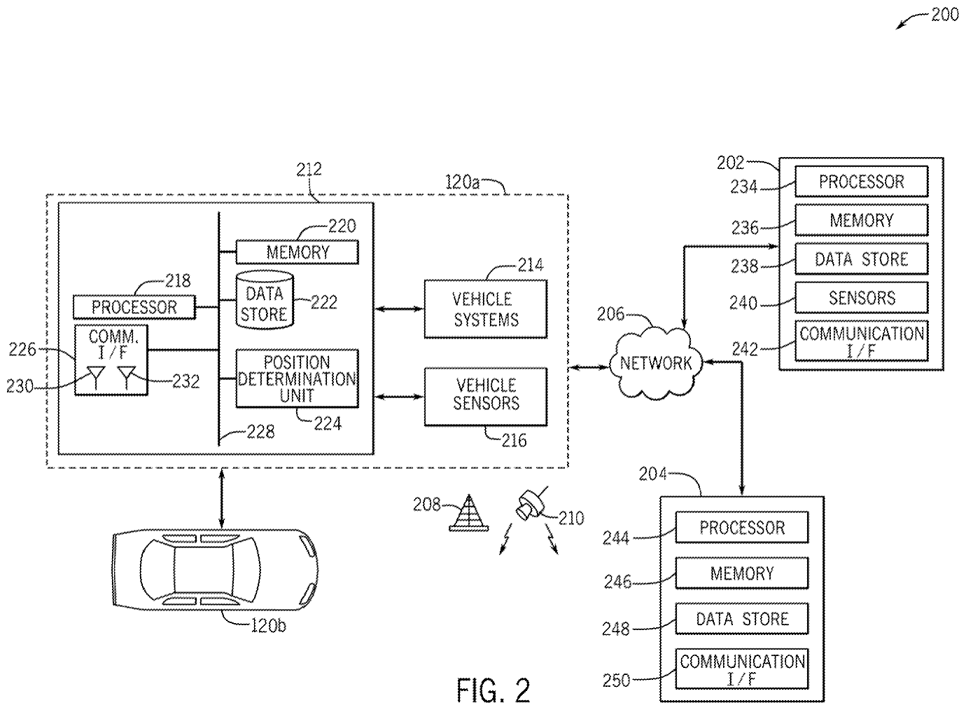

Referring now to FIG. 2, an exemplary smart traffic assistant system 200 according to one embodiment is shown. As mentioned above, the system 200 can be implemented with the elements shown in FIG. 1, and for convenience, like names and numerals represent like elements. In FIG. 2, the system 200 includes the vehicle 120a, the vehicle 120b, a traffic infrastructure computing device 202 and an assistant computing device 204, each of which can be operatively connected for computer communication using, for example, a network 206. The network 206 can include any type of communication protocols or hardware described herein. For example, computer communication using the network 206 can be implemented using a wireless network antenna 208 (e.g., cellular, mobile, satellite, or other wireless technologies).

Although not shown in FIG. 2, it is understood that the vehicle 120b, the vehicle 120c, the vehicle 120d, the vehicle 120e, the vehicle 120f, the vehicle 120g, the vehicle 120, and the vehicle 120i can include one or more of the components and/or functions discussed herein with respect to the vehicle 120a. Thus, it is understood that although not shown in FIG. 2, one or more of the computer components and/or functions discussed herein with the vehicle 120a, can also be implemented with and/or executed in whole or in part with one or more of the vehicles 120, the traffic infrastructure computing device 202, the assistant computing device 204, other entities, traffic devices, and/or connected devices (e.g., V2I devices, V2X devices) operable for computer communication with the system 200. Further, it is understood that the components of the vehicle 120a and the system 200, as well as the components of other systems, hardware architectures, and software architectures discussed herein, can be combined, omitted, or organized into different architectures for various embodiments.

The vehicle 120a includes a vehicle computing device (VCD) 212, vehicle control systems 214, and vehicle sensors 216. Generally, the VCD 212 includes a processor 218, a memory 220, a data store 222, a position determination unit 224, and a communication interface (I/F) 226, which are each operably connected for computer communication via a bus 228 and/or other wired and wireless technologies discussed herein. Referring again to the vehicle 120a, the VCD 212, can include provisions for processing, communicating and interacting with various components of the vehicle 120a and other components of the system 200, including the vehicle 120b, the traffic infrastructure computing device 202, and the assistant computing device 204.

The processor 218 can include logic circuitry with hardware, firmware, and software architecture frameworks for facilitating control of the vehicle 120a and facilitating communication between the vehicle 120a, the vehicle 120b, the traffic infrastructure computing devices 202, and the assistant computing device 204. Thus, in some embodiments, the processor 218 can store application frameworks, kernels, libraries, drivers, application program interfaces, among others, to execute and control hardware and functions discussed herein. In some embodiments, the memory 220 and/or the data store (e.g., disk) 222 can store similar components as the processor 218 for execution by the processor 218.

The position determination unit 224 can include hardware (e.g., sensors) and software to determine and/or acquire position data about the vehicle 120a and position data about other vehicles and objects in proximity to the vehicle 120a. For example, the position determination unit 224 can include a global positioning system unit (not shown) and/or an inertial measurement unit (not shown). Thus, the position determination unit 224 can provide a geoposition of the vehicle 120a based on satellite data from, for example, a global position satellite 210. Further, the position determination unit 224 can provide dead-reckoning data or motion data from, for example, a gyroscope, accelerometer, magnetometers, among other sensors (not shown). In some embodiments, the position determination unit 224 can be a navigation system that provides navigation maps, map data, and navigation information to the vehicle 120a or another component of the system 200 (e.g., the assistant computing device 204).

The communication interface (I/F) 226 can include software and hardware to facilitate data input and output between the components of the VCD 212 and other components of the system 200. Specifically, the communication I/F 226 can include network interface controllers (not shown) and other hardware and software that manages and/or monitors connections and controls bi-directional data transfer between the communication I/F 226 and other components of the system 200 using, for example, the network 206. As another example, the communication I/F 226 can facilitate communication (e.g., exchange data and/or transmit messages) with one or more of the vehicles 120.

Referring again to the vehicle 120a, the vehicle control systems 214 can include any type of vehicle system described herein to enhance the vehicle 120a and/or driving of the vehicle 120a. The vehicle sensors 216, which can be integrated with the vehicle control systems 214, can include various types of sensors for use with the vehicle 120a and/or the vehicle control systems 214 for detecting and/or sensing a parameter of the vehicle 120a, the vehicle systems 214, and/or the environment surrounding the vehicle 120a. For example, the vehicle sensors 216 can provide data about vehicles in proximity to the vehicle 120a, data about the traffic junction 110 and/or the pedestrians 124. As an illustrative example, the vehicle sensors 216 can include ranging sensors to measure distances and speed of objects surrounding the vehicle 120a (e.g., other vehicles 120, pedestrians 124). Ranging sensors and/or vision sensors can also be utilized to detect other objects or structures (e.g., the traffic junction 110, the traffic signal devices 112, the crosswalk signal devices 118, and the crosswalks 116). As will be discussed in more detail herein, data from the vehicle control systems 214 and/or the vehicle sensors 216 can be referred to as sensor data or input data and utilized for smart traffic assistance.

Referring again to FIG. 2, the traffic infrastructure computing device 202 includes a processor 234, a memory 236, a data store (e.g., a disk) 238, sensors 240, and a communication interface (I/F) 242. It is understood that the traffic infrastructure computing device 202 can be any type of device with computing capabilities. For example, in FIG. 1, the traffic signal device 112a, the traffic signal device 112a, the crosswalk signal device 118a, the crosswalk signal device 118b, and the crosswalk signal device 118c can be implemented as the traffic infrastructure computing device 202. Furthermore, the system 200 can include more than one traffic infrastructure computing device 202.

Referring again to FIG. 2, the processor 234 can include logic circuitry with hardware, firmware, and software architecture frameworks for facilitating operation and control of the traffic infrastructure computing device 202 and any other traffic infrastructure devices described herein. For example, when implemented as the traffic signal device 112a, the processor 234 can control traffic signal timing at the traffic junction 110 by changing one or more parameters of the traffic signal device 112a. This can include changing lights or colors of indicators to indicate different traffic movements. The processor 234 can store application frameworks, kernels, libraries, drivers, application program interfaces, among others, to execute and control hardware and functions discussed herein. In some embodiments, the memory 236 and/or the data store (e.g., disk) 238 can store similar components as the processor 234 for execution by the processor 234.

The sensors 240 can include various types of sensors for monitoring and/or controlling traffic flow. For example, the sensors 240 can include visions sensors, (e.g., imaging devices, cameras) and/or ranging sensors (e.g., RADAR, LIDAR), for detecting and capturing data about the vehicles 120, the pedestrians 124, and the traffic junction 110. As an illustrative example with reference to FIG. 1, the sensors 240 can include the camera 114a and/or the camera 114b.

The communication I/F 242 can include software and hardware to facilitate data input and output between the components of the traffic infrastructure computing device 202 and other components of the system 200. Specifically, the communication I/F 242 can include network interface controllers (not shown) and other hardware and software that manages and/or monitors connections and controls bi-directional data transfer between the communication I/F 242 and other components of the system 200 using, for example, the network 206. Thus, the traffic infrastructure computing device 202 is able to communicate sensor data acquired by the sensors 240 and data about the operation of the traffic infrastructure computing device 202 (e.g., timing, cycles, light operation). As will be discussed in more detail herein, data from the sensors 240 can be referred to as sensor data or input data and utilized for smart traffic assistance.

Referring again to the system 200 of FIG. 2, the assistant computing device 204 includes a processor 244, a memory 246, a data store (e.g., a disk) 248, and a communication interface (I/F) 250. The processor 244 can include logic circuitry with hardware, firmware, and software architecture frameworks for smart traffic assistance as described herein. In particular, the processor 244 with the communication I/F 250 facilitates managing interactions and/or communication between road agents to coordinate execution of a desired action at the traffic junction 110. In some embodiments, the processor 244 can store application frameworks, kernels, libraries, drivers, application program interfaces, among others, to execute and control hardware and functions discussed herein. In some embodiments, the memory 246 and/or the data store (e.g., disk) 248 can store similar components as the processor 244 for execution by the processor 244.

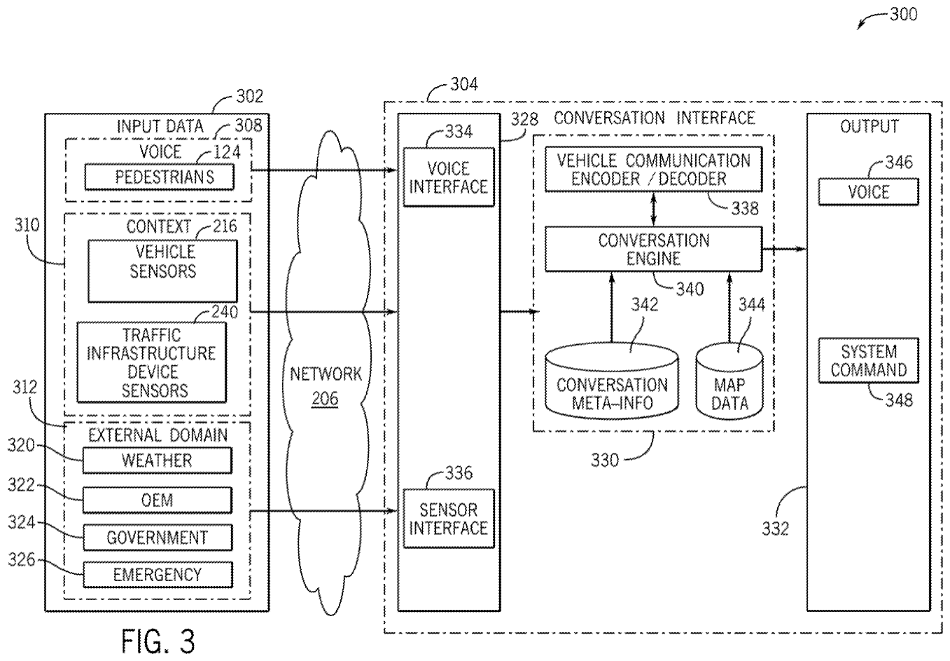

Further, the communication I/F 250 can include software and hardware to facilitate data input and output between the assistant computing device 204 and other components of the system 200. Specifically, the communication I/F 250 can include network interface controllers (not shown) and other hardware and software that manages and/or monitors connections and controls bi-directional data transfer between the communication I/F 250 and other components of the system 200 using, for example, the network 206. In one embodiment, which will be described with FIG. 3, the communication I/F 250 includes a conversation interface (I/F) managing interactions and/or communication between road agents to coordinate execution of a desired action at the traffic junction 110.

### II. Smart Traffic Assistant Processing Overview

FIG. 3 is a block diagram 300 illustrating exemplary processing of input data 302 by a conversation interface (I/F) 304 according to one embodiment. In this exemplary embodiment, one or more components and/or functions of the conversation I/F 304 can be a component of the assistant computing device 204 and/or the communication I/F 250. The conversation I/F 304 can interact with the input data 302 using, for example, the network 206 and one or more connected devices or sensors, for example, the VCD 212 and/or the traffic infrastructure computing device 202. In one embodiment, one or more components of the assistant computing device 204 including the conversation I/F 304 can be considered a cloud infrastructure system that provides cloud services, namely, smart traffic assistant services. For convenience, FIG. 3 is described with reference to FIGS. 1 and 2, and like names and numerals represent like elements.

Referring to the block diagram 300 of FIG. 3, the input data 302 the input data 302 can include voice data 308, context data 310, and external domain data 312, however it is understood that the input data 302 can include other types of data having any type of mode (e.g., e.g., audio, video, text). In some embodiments discussed herein, input data 302 can be referred to as “sensor data” and can include on or more of the voice data 308, the context data 310, and the external domain data 312. Each type of input data 302 including exemplary sources of the input data 302 will now be discussed in detail.

The voice data 308 can include voice and/or speech data (e.g., utterances emitted from one or more of the pedestrians 124. Thus, the voice data 308 can include an active audio input from one or more of the pedestrians 124 forming part of a conversation with the assistant computing device 204. The voice data 308 can also include any audible data detected in proximity to the traffic junction 110. As will be discussed herein, in some embodiments, the voice data 308 is captured by the traffic infrastructure computing device 202 (e.g., the sensors 240).

The context data 310 includes data associated with the traffic junction 110, the vehicles 120, and/or the pedestrians 124 that describe the environment of the traffic junction 110. For example, context data 310 can include sensor data captured by the vehicle sensors 216 and/or the sensors 240.

The external domain data 312 includes data from remote servers and/or services not shown. In some embodiments, the vehicle 120a and/or the traffic infrastructure computing device 202 can retrieve the external domain data 312 from remote servers and/or services and shown and send the external domain data 312 to the assistant computing device 204 for processing by the conversation interface 304. In FIG. 3, the external domain data 312 includes weather data 320 (e.g., forecast data, weather data, road conditions) from, for example, a remote weather server or service. The external domain data 312 also includes original equipment manufacturer (OEM) data 322 (e.g., any type of vehicle data associated with the OEM) from, for example, a remote OEM server or service. The external domain data 312 also includes government data 324 (e.g., traffic regulations and laws, road design requirements, transportation data) from a remote governmental agency server or service. Further, the external domain data 312 can include emergency data 326 (e.g., emergency vehicle data, emergency vehicle type, emergency vehicle location, emergency vehicle current status) from a remote public agency server or service. The multi-modal input data described above can be combined and analyzed for conversation processing and smart traffic assistance by the conversation interface 304. Thus, as will be described in more detail below, the voice data 308, the context data 310, and/or the external domain data 312 can be combined to facilitate clear communication between the vehicles 120 and the pedestrians 124 and resolve traffic scenarios at the traffic junction 110.

Generally, the conversation I/F 304 manages communication and interaction between the components of the system 200. The input data 302, which is received from the computing devices and sensors shown in FIG. 2 is transmitted to the conversation I/F 304 using, for example, the network 206. The conversation I/F 304 processes the input data 302 together for analysis, recognition, translation, and control generation. More specifically, in FIG. 3, the conversation I/F 304 can include an input interface 328, a translation interface 330, and an output interface 332. The input interface 328 can be configured to perform various techniques to process input data 302. It is understood that the input interface 328 can include any type of data or signal processing techniques to condition the input data 302 for further processing by the translation interface 330. Thus, in the embodiment shown in FIG. 3, the input interface 328 can include a voice interface 334, a sensor interface 336, and/or any other type of data mode processing interface. The voice interface 334 processes the voice data 308. The sensor interface 336 processes the context data 310 and/or the external domain data 312. In some embodiments, this input data processing can be performed by the sensors and/or devices capturing the data themselves.

The translation interface 330 is the hub of the smart traffic assistant described herein that combines artificial intelligence and linguistics to handle interactions and conversations between vehicles 120 and pedestrians 124. For purposes of the systems and methods described herein, a conversation can include a plurality of information and other data related to one or more exchanges between the pedestrians 124 and the vehicles 120. This information can include words and/or phrases spoken by the pedestrians 124, queries presented by the pedestrians 124, sensor data received from one or more sensors and/or systems, vehicle data from the vehicles 120, vehicle messages from the vehicles 120, and/or context data about the traffic junction 110, the pedestrians 124, and/or the vehicles 120.

Generally, the translation interface 330 includes a communication encoder/decoder 338, a conversation engine 340, conversation meta-info 342, and map data 344. The communication encoder/decoder 338 and the conversation engine 340 can: process the input data 302 into a format that is understandable by the translation interface 330, utilize Natural Language Processing (NLP) to interpret a meaning and/or a concept with the input data 302, identify or perform tasks and actions, and generate responses and/or outputs (e.g., at output interface 332) based on the input data 302. The conversation meta-info 342 can include linguistic data, NLP data, intent and/or response templates, current and/or historical conversation history, current and/or historical conversation output, among other types of static or learned data for conversation processing. The map data 344 can include map and location data, for example, map data about the traffic junction 110. As will be discussed in more detail herein, the vehicle communication encoder/decoder 338 facilitates translation from human-readable medium to vehicle-readable medium and vice versa with assistance from the conversation engine 340.

The output interface 332 facilitates generation and output in response to the processing performed by the translation interface 330. For example, output interface 332 includes a voice interface 346 and a system command interface 348. The voice interface 346 can output speech to, for example, a connected device (e.g., the traffic infrastructure computing device 202) in proximity to the desired recipient pedestrian. The system command interface 348 can transmit a command signal to a connected device and/or a vehicle to control the connected device and/or the vehicle. The output interface 332 and the other components of the conversation interface 304 will now be described in more detail with exemplary smart assistant methods.

### III. Methods for Smart Traffic Assistant Processing

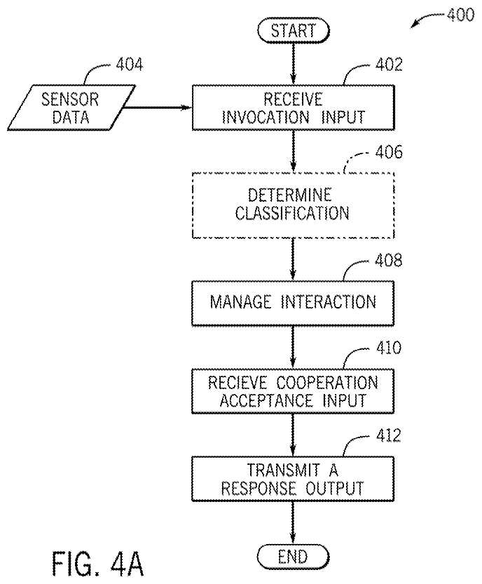

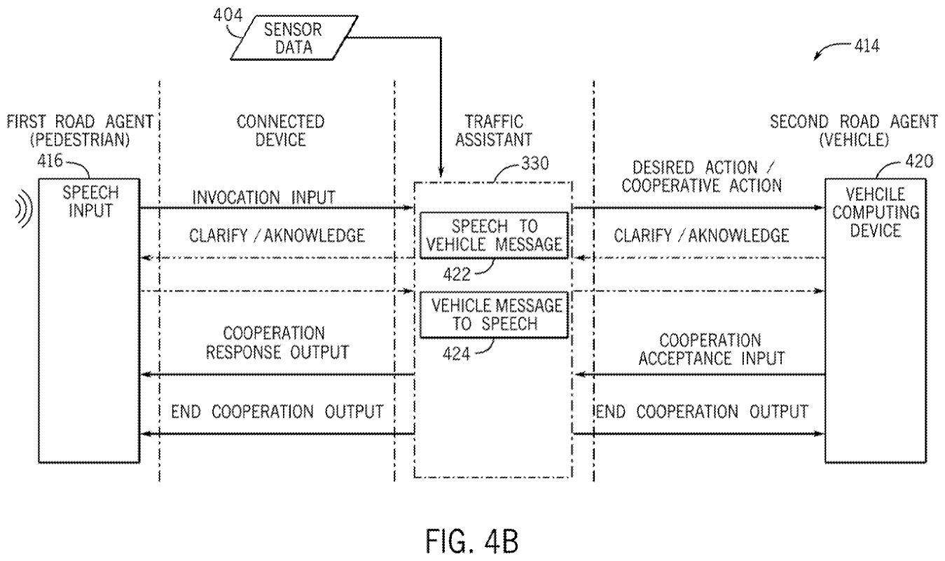

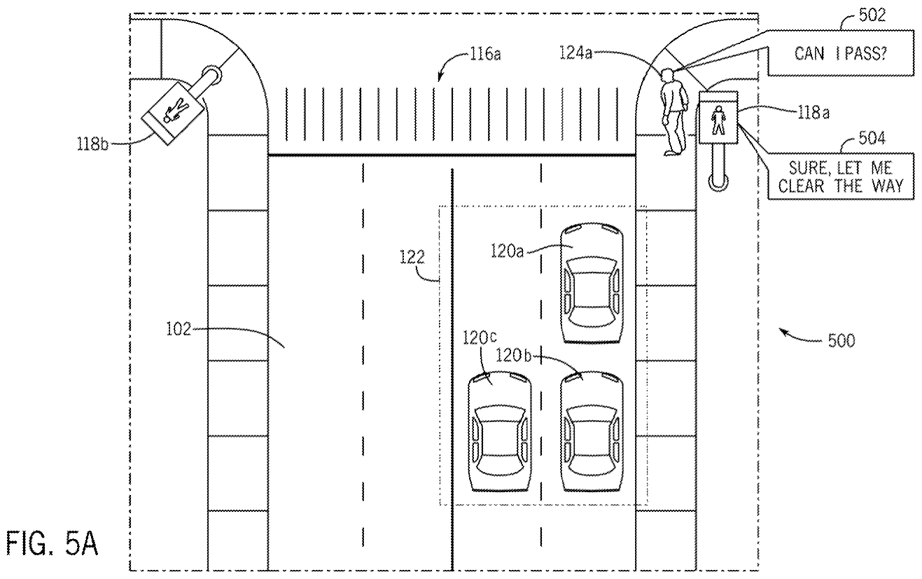

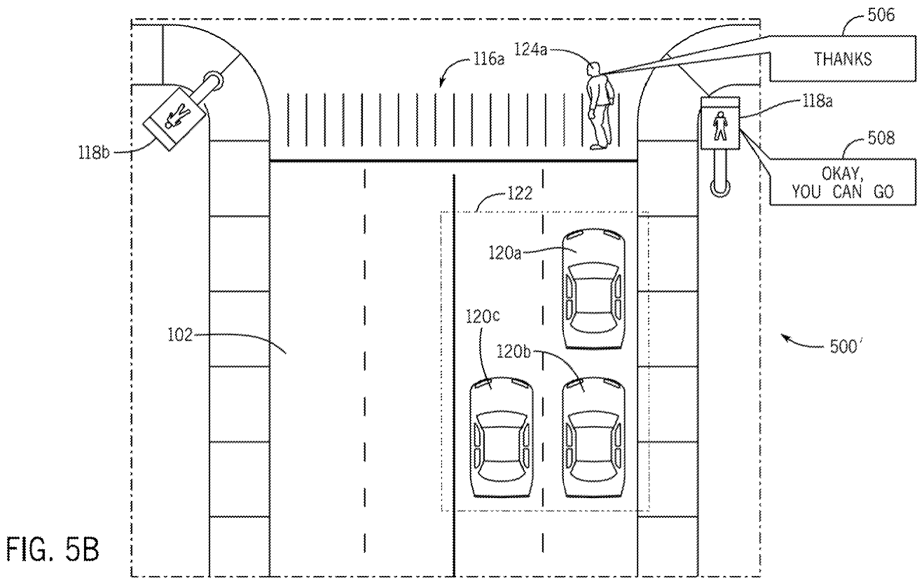

FIG. 4A is a flow diagram of a smart traffic assistant method 400 according to one embodiment and FIG. 4B is a functional flow diagram 414 of an example according to the method 400. FIGS. 5A and 5B are illustrative examples that will be described applying FIGS. 4A and 4B. It is understood that one or more blocks of FIGS. 4A and 4B can be implemented with one or more components of FIGS. 1-3. Accordingly, FIGS. 4A and 4B will be described with reference to FIGS. 1-3. For convenience, like names and numerals represent like elements. Referring now to FIG. 4A, the method 400 includes at block 402 receiving invocation input. The invocation input can include sensor data 404. It is understood that the sensor data 404 can be retrieved separately from the invocation input at any block in method 400. As described herein, the sensor data 404 can be captured and/or received from one or more connected devices in proximity to the traffic junction 110. Sensor data 404 can also be received from one or more of the vehicles 120. Additionally, the sensor data 404 can include the input data 302 described with FIG. 3.

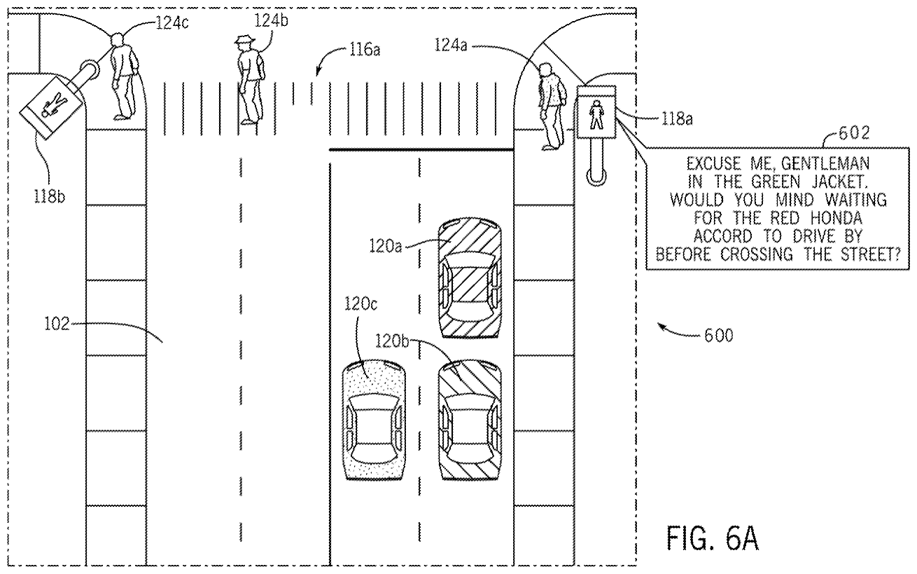

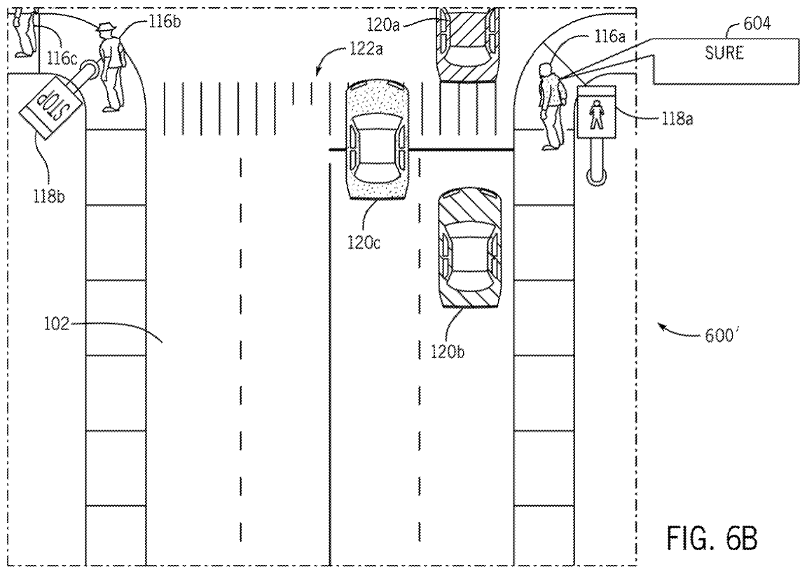

Initially, the invocation input triggers the assistant computing device 204 to initiate a conversation and provide smart traffic assistance. In one embodiment, the invocation input includes a desired action to be executed at the traffic junction 110 by at least one first road agent. In some embodiments, the first road agent is a road user (e.g., a pedestrian 124a) and the second road agent is a vehicle (e.g., the vehicle 120a). In this embodiment, the invocation input is a voice utterance from the first road agent, which is shown in FIGS. 4B and 5A. In this example, the first road agent initiates the interaction. However, it is understood that in other embodiments, which will be described in more detail herein with FIGS. 6A and 6B, the one or more connected devices and/or one or more of the vehicles 120 can initiate the interaction.

With reference first to FIG. 4B, a speech input 416 from a first road agent (e.g., the pedestrian 124a) is captured and sent to the translation interface 330, which can be a part of the traffic infrastructure computing device 202 and/or the assistant computing device 204. One or more connected devices can be utilized to capture and transmit the speech input 416. For example, the traffic infrastructure computing device 202 using the sensors 240 can capture the speech input 416.

With reference to FIG. 5A, a detailed view 500 of the traffic junction 110 of FIG. 1 is shown. Here, the pedestrian 124a (e.g., the first road agent, the road user) is shown uttering a phrase 502, namely, “Can I pass?” In this embodiment, the crosswalk signal device 118a captures the phrase 502 as the speech input 416. This invocation input from the pedestrian 124a initializes the assistant computing device 204 to provide smart traffic assistance. In the example shown in FIG. 5A, the speech input 416 includes a desired action to be executed by the pedestrian 124, namely, walk across the first road segment 102 at the crosswalk 116a. The crosswalk signal device 118a transmits the speech input 416 to the translation interface 330 for processing. In some embodiments, which will be described herein, the translation interface 330 can identify the desired action in the invocation input based on the speech input 416 and/or the sensor data 404.

Referring again to FIG. 4A, at block 406, the method 400 can optionally include determining a classification of the road user. For example, the processor 244 can analyze sensor data to determine characteristics and parameters about the pedestrian 124a. The processor 244 can classify the pedestrian 124a by age (e.g., child, adult, elderly), gender, weight, height, among other classifications. In other embodiments, the processor 244 can classify the pedestrian 124a by a visually apparent physical characteristic of the pedestrian 124a. For example, a characteristic describing hair, clothing, figure, face, among others. Additionally, attributes of these characteristics can also be used for classification of the pedestrian 124a, for example, hair color, shirt color, pants, dress, bag, glasses, among others. In some embodiments, the processor 144 can also classify and/or determine if the pedestrian 124a has a disability (e.g., vision impairment, hearing impairment, physical impairment). As will be discussed in further detail herein, the classification of the road user can be used to manage interactions between road agents, generate a command signal to control a road agent, and/or generate a response output to a road agent.

The method 400 also includes at block 408 managing interactions between road agents. Generally, managing interactions between road agents includes conversation management, translation between human-readable mediums and vehicle-readable mediums, and control of the road agents with responsive outputs. The processor 244 and the translation interface 330 facilitate the processing and execution at block 408.

As mentioned above, managing the interactions between the first road agent and the second road agent can be based on at least the invocation input and the sensor data 404. As shown in FIG. 4B, the translation interface 330 receives the invocation input in the form of speech input 416. In one embodiment, the translation interface 330 processes the speech input 416 and/or the sensor data 404 using natural language processing (NLP) as described with FIG. 3. The translation interface 330 can use NLP to identify prompts, scenes, types, intentions, and other conversational actions based on the speech input 416 and/or the sensor data 404. In some embodiments, the translation interface 330 uses NLP to determine conversational responses and/or conversational actions based on the speech input 416. For example, as shown in FIG. 4B, the translation interface 330 can generate a conversational output to the first road agent and/or the second road agent with clarifying and/or acknowledgement output. This type of output and dialogue can help clarify the details of the invocation input (e.g., the desired action, the cooperative action) and/or help the first road agent and/or the second road agent understand the current status of entities involved in the interaction. As an illustrative example shown in FIG. 5A, the crosswalk signal device 118a outputs a phrase 504, “Sure, let me clear the way.” This provides notice to the pedestrian 124a that the speech input was received and the pedestrian 124a should wait for further instructions.

Referring again to FIGS. 4A and 4B, in some embodiments, managing the interactions at block 408 includes identifying a desired action and/or a cooperative action based on the speech input 416, the sensor data 404, and/or the classification of the road user. A desired action is an action requested to be performed by a road agent at the traffic junction 110. Therefore, the desired action identifies not only an action but also an actor to perform the action. In some situations, to perform the desired action a cooperative action by another entity at the traffic junction 110 may be required. As mentioned above with FIG. 5A, the pedestrian 124a is requesting to walk across the first road segment 102 at the crosswalk 116a. In this example, the desired action is the pedestrian 124a crossing the first road segment 102 at the crosswalk 116a. In order to execute the desired action, a cooperative action is required by at least the vehicle 120a and/or the traffic signal device 112b. Specifically, the vehicle 120a must remain in a stopped state at the crosswalk 116a and/or the timing of the traffic signal device 112b must be modified to control the traffic flow and thereby control the vehicle 120a to allow the pedestrian 124a to cross the crosswalk 116a.

As shown in FIG. 4B, the desired action and/or the cooperative action derived from the speech input 416 and the sensor data 404 is communicated to the vehicle 120a to coordinate execution of the desired action and/or the cooperative action. Accordingly, in one embodiment, the speech input 416 and/or the sensor data 404 are translated at block 422, speech-to-vehicle message. More specifically, the processor 244 can process the speech input 416 and the sensor data 404 into a vehicle-readable format, namely, a vehicle message. In some embodiments, the vehicle message includes the desired action and/or the cooperative action. The vehicle message can also include a command signal having a vehicle-readable format to control the vehicle.

Thus, in one embodiment, managing the interactions at block 408 includes translating human-readable medium to vehicle-readable medium in a back-and-forth manner between the first road agent (e.g., the pedestrian 126a) and a second road agent (e.g., the vehicle 120a) to coordinate execution of the desired action. In one embodiment, this includes processing the voice utterance (e.g., the speech input 416) and the sensor data 404 into a command signal having a vehicle-readable format with instructions to control the vehicle 120a to execute the cooperation action, and the processor 244 transmitting the command signal to the vehicle 120a to execute the cooperation action.

The vehicle-readable format can include the command signal capable of being executed by the vehicle 120a and/or a vehicle message capable of being processed by the vehicle 120a. In one embodiment, the vehicle message is in a defined message format, for example as a Basic Safety Message (BSM) under the SAE J2735 standard. Accordingly, the translation from human-readable medium to vehicle-readable medium includes converting and formatting the human-readable medium into a BSM that contains information about vehicle position, heading, speed, and other information relating to a vehicle's state and predicted path according to the desired action and the cooperative action.

In another embodiment, the command signal has a machine-readable format with instructions to control one or more of the connected devices (e.g., the traffic infrastructure computing device 202) to execute the cooperating action. Thus, managing interactions at block 408 includes converting interactions from human-readable medium to machine-readable medium and vice versa. For example, translating the sensor data and the invocation input into a format capable of being processed by the second road agent. In the case where the invocation input includes a voice utterance, the voice utterance is translated into a command signal to control the second road agent.

In some embodiments, managing the interactions at block 408 can include managing the interactions based on the classification of the road user determined at block 406. In one embodiment, the sensor data 404, the speech input 416, and/or the classification is used to determine conversational actions, conversational responses, desired actions and/or the cooperative action. As an illustrative example, if the pedestrian 124a is classified as having a physical disability, the timing of the cooperative action can be modified to allow the pedestrian 124a additional time to walk across the first road segment 102. Thus, the vehicle 120a must remain in a stopped state for a longer period of time and/or the timing of the traffic signal device 112b is modified to control the length of time the vehicle 120a is in a stopped state. In another example, conversational responses can be tailored based on a classification of the pedestrian 124a. For example, as will be described below in more detail with block 412, output to the pedestrian 124a can be directed specifically to the pedestrian 124a based on a classification of the pedestrian 124a (e.g., a physical characteristic of the pedestrian 124a).

Referring again to FIG. 4A, at block 410 the method 400 includes receiving a cooperation acceptance input. The cooperation acceptance input is received from the second road agent (e.g., the vehicle 120a) and indicates an acceptance to coordinate execution of the desired action or a non-acceptance to coordinate execution of the desired action. Thus, the cooperation acceptance is an agreement to execute a cooperation action by the second road agent (e.g., the vehicle 120a) thereby allowing execution of the desired action by the first road agent (e.g., the pedestrian 124a). In some embodiments, the cooperation acceptance input can indicate that the cooperation action has been completed.

In FIG. 4B, a cooperation acceptance input is sent by the second road agent and received by the translation interface 330. In one embodiment, the cooperation acceptance input is a vehicle message received from the second road agent. Accordingly, the translation interface 330 can translate the vehicle message (e.g., vehicle-readable medium) into a human-readable medium that the first road agent is capable of understanding at block 424, vehicle message-to-speech. The translation of the vehicle message can be output to the first road agent as a response output, which will now be described in more detail.

Referring again to the method 400 of FIG. 4A, block 412 includes transmitting a response output. The response output is transmitted to the one or more connected devices and can be based on the cooperation acceptance input. In one embodiment, the response output is speech output and includes instructions to invoke the desired action. In the scenario where the cooperation acceptance input is a vehicle message received from the second road agent, transmitting the response output includes translating the vehicle message to a speech output. For example, in FIG. 4B, the cooperation acceptance input is processed at block 424, vehicle message-to-speech. This results in a cooperation response output (e.g., a speech output) that instructs the first road agent to perform the desired action. For example, with reference to FIG. 5B, upon receiving a cooperation acceptance input from the vehicle 120a, the crosswalk signal device 118a output phrase 508, “Okay, you can go.” In one embodiment, the processor 244 transmits the speech output to a selected connected device that is closest in proximity to the intended recipient (e.g., road agent) of the response output.

In some embodiments, transmitting the response output at block 412 can be based on the classification determined at block 406. More specifically, the response output can be modified based on the classification of the intended recipient (e.g., road agent). This can be helpful to catch the attention of the intended recipient. For example, based on the classification determined at block 406, the pedestrian 124a is identified as wearing a red shirt. In this example, the output phrase 508 can be modified to identify the actor of the action, namely, “Okay, the pedestrian in the red shirt can go.” This provides for clear communication particularly if there are other road users in proximity to the connected device and/or the pedestrian 124a. A unique classification of the pedestrian 124a when compared to other road agents in proximity to the connected device and/or the pedestrian 124a is preferable. This type of interactive and identifying communication will also be described in more detail with FIGS. 6A and 6B.

In some embodiments, the conversation interface 304 can continue to manage interactions between the first road agent and the second road agent. For example, as shown in FIG. 4B, the conversation interface 304 can transmit output that indicates the end of the conversation and/or the cooperation. In some embodiments, the conversation interface 304 can also provide notifications about the interactions to other road users in proximity to the area where the desired action and/or the cooperative action is executed. For example, other road agents (not shown) could be notified via a vehicle computing device and/or a portable device (not shown) in possession of the road agent using wireless communication (e.g., the network 206). In other embodiments, the conversation interface 304 can update the map data 344 with data about the interactions. The map data 344 can be used to notify other road agents using, for example, wireless communication (e.g., the network 206). In this way, communication and traffic scenarios are made transparent to other road agents who may be affected.

In the examples described above with FIGS. 4B, 5A, and 5B, the first road agent is a road user (e.g., a pedestrian 124a) and the second road agent is a vehicle (e.g., the vehicle 120a). However, in some embodiments, one or more of the connected devices and/or one or more of the vehicles 120 can initiate the interaction as the first road agent and one or more road users can be considered the second road agent. Additionally, as discussed above, classification of road users can be used to facilitate the assistant and conversation methods. An illustrative example for smart traffic assistance with classification will now be described with reference to FIGS. 6A and 6B.

FIG. 6A is a detailed view 600 of the traffic junction 110 of FIG. 1. In this illustrative example, the view 600 shows the pedestrian 124a nearing the crosswalk 116a to walk across the first road segment 102 at the crosswalk 116a. The pedestrian 124b is in the process of walking across the first road segment 102 at the crosswalk 116a. The pedestrian 124c has completed walking across the first road segment 102 at the crosswalk 116a and has made it to the sidewalk off the first road segment 102. Furthermore, the vehicle 120a, the vehicle 120b, and the vehicle 120c are stopped and waiting to cross over the traffic junction 110 (i.e., from the first road segment 102a to the third road segment 106a). In this example, the vehicles 120 have been patiently waiting (e.g., according to the traffic signal device 112b and/or the crosswalk signal device 118a) for the pedestrian 124b and the pedestrian 124c to finish crossing the first road segment 102. Instead of requiring the vehicles 120 to continue waiting in a stopped state to allow the pedestrian 124a to cross the crosswalk 116a, the vehicles 120 and/or one or more of the connected devices (e.g., the traffic signal device 112b and/or the crosswalk signal device 118a) can initiate a conversation and/or provide the invocation input to cause the pedestrian 124a to wait at the crosswalk 116a for the vehicles 120 to pass.

In the example shown in FIG. 6A, the conversation to cause the pedestrian 124a to wait at the crosswalk 116a can include classification and/or identification of the pedestrians 124 and/or the vehicles 120. As discussed above at block 406, the systems and methods can classify and/or identify road users by a characteristic of the road users. FIG. 6A provides examples of visually apparent physical characteristics that can be used to differentiate one road user from another road user. For example, the pedestrian 124a is wearing a jacket, while the pedestrian 124b is wearing a short sleeved shirt. The jacket of the pedestrian 124a has shading indicating a color (e.g., green). The green jacket can be used as a classification and/or an identification of the pedestrian 124a. As another example, the hat worn by the pedestrian 124b can be used as a classification and/or an identification of the pedestrian 124b. With respect to the vehicles 120, in FIG. 6a different shading and/or patterns are used to represent a distinguishing feature, for example, a color, a make/model, among others. As discussed above at block 406, these classifications and/or identifications can be used to facilitate conversations at the traffic junction 110.

As mentioned above with FIG. 4A and block 402 and with FIG. 4B, sensor data 404 can be used to identify prompts, scenes, types, intentions, and other actions based on the speech input 416 and/or the sensor data 404. Accordingly, in the example shown in FIGS. 6A and 6B, the invocation input and/or the sensor data 404 can include data from the traffic signal device 112b, the camera 114b, the crosswalk signal device 118a, the vehicle 120a, the vehicle 120b, and/or the vehicle 120c. In one example, the conversation interface 304 can translate the machine data from the sensor data 404 to determine a desired action and/or a cooperative action. For example, based on timing information from the traffic signal device 112b, image data of the traffic junction 110 from the camera 114b, and/or BSM messages about the vehicle state and navigation of one or more of the vehicles 120, the conversation interface 304 can determine the one or more vehicles 120 have been waiting too long. Here, the desired action is for the one or more vehicles 120 to cross the traffic junction 110 and the cooperative action is for the pedestrian 124a to remain in a stopped state and wait for the vehicles to pass. As another example, the one or more vehicles 120 could transmit a BSM message with a request to cross the traffic junction 110 and/or a request to ask the pedestrian 124a to wait.

As discussed in detail above with FIG. 4, the translation interface 330 can generate a conversational output to the first road agent and/or the second road agent to coordinate execution of the desired action and/or the cooperative action. The conversational output can also be generated based on classification. In the example of FIG. 6A, the crosswalk signal device 118a outputs a phrase 602 “Excuse me, gentleman in the green jacket. Would you mind waiting for the red Honda Accord to drive by before crossing the street?.” The phrase 602 indicates the desired action (i.e., the vehicles 120 to cross the traffic junction 110) and the cooperative action (i.e., the pedestrian 124a waiting). The phrase 602 also uses classification for clarity of the actions. Namely, the intended recipient (i.e., the pedestrian 124a) is identified as wearing a green jacket. Thus, the pedestrian 124b and the pedestrian 124c, should they hear the phrase 602, will understand the phrase 602 is intended for the pedestrian 124a.

Furthermore, the instructions in the phrase 602 includes classification of one or more of the vehicles 120. For example, the classification of the “red Honda Accord” identifies the vehicle 120b, which is the last vehicle to cross the traffic junction 110 (see FIG. 6B). Accordingly, the cooperation action directed to the pedestrian 124a is clarified using the classification to ensure the pedestrian 124a waits until the vehicle 120b passes. It is understood that other conversational actions discussed herein can be applied to the example shown in FIGS. 6A and 6B. For example, in FIG. 6B, a voice utterance 604, namely, “Sure” is processed as a cooperation acceptance input from the pedestrian 124a indicating an agreement to execute the cooperation action (i.e., waiting) thereby allowing execution of the desired action (i.e., cross the traffic junction 110) by the vehicles 120. In some embodiments, the conversation interface 304 can continue to manage interactions between the first road agent and the second road agent. For example, the conversation interface 304 can transmit output (e.g., a BSM) to the vehicles 120 indicating the vehicles 120 can proceed to cross the traffic junction 110. In some embodiments, the conversation interface 304 can also provide notifications about the interactions to other road users in proximity to the traffic junction 110. In this way, communication and traffic scenarios are made transparent to other road users who may be affected.

It will be appreciated that various embodiments of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for assisting road agents including a first road agent and a second road agent, comprising:
connected devices in proximity to a traffic junction that capture sensor data about the road agents and the traffic junction; and
a processor operably connected for computer communication to the connected devices, the processor configured to:
receive an invocation input including a desired action to be executed at the traffic junction;
manage interactions between the road agents to coordinate execution of the desired action by converting human-readable medium to vehicle-readable medium in a back-and-forth manner;
receive a cooperation acceptance input from the second road agent indicating an acceptance to coordinate execution of the desired action or a non-acceptance to coordinate execution of the desired action; and
transmit a response output invoking the desired action based on the cooperation acceptance input.

2. The system of claim 1, wherein the first road agent is a road user and the second road agent is a vehicle.

3. The system of claim 2, wherein the invocation input is a voice utterance emitted by the first road agent and the processor is further configured to receive the invocation input from the connected devices.

4. The system of claim 3, wherein the processor configured to manage interactions between the road agents further includes processing the voice utterance and the sensor data into a command signal having a vehicle-readable format to control the vehicle.

5. The system of claim 4, further including the processor configured to transmit the command signal to the vehicle, thereby controlling the vehicle to perform a cooperation action thereby allowing the desired action to be executed.

6. The system of claim 2, wherein the cooperation acceptance input is a vehicle message received from the vehicle, and wherein the processor configured to transmit the response output invoking the desired action further includes converting the vehicle message to a human-readable medium instructing the road user to perform the desired action.

7. The system of claim 6, wherein the human-readable medium is a speech output.

8. The system of claim 7, further including the processor configured to transmit the speech output to a selected connected device of the connected devices in closest proximity to the road user.

9. The system of claim 2, further including the processor configured to determine a classification of the road user based on the sensor data.

10. The system of claim 9, further including the processor configured to determine the desired action to be executed at the traffic junction based on the invocation input and the classification of the road user.

11. The system of claim 10, further including the processor configured to generate the response output invoking the desired action based on the classification of the road user.

12. A computer-implemented method for assisting road agents at a traffic junction, where the road agents include at least a first road agent and a second road agent, comprising:
receiving sensor data from one or more connected devices in proximity to the traffic junction, wherein the sensor data includes an invocation input with a desired action to be executed at the traffic junction by the first road agent;
managing interactions between the first road agent and the second road agent based on the sensor data and the desired action including converting interactions from human-readable medium to machine-readable medium and vice versa;
receiving a cooperation acceptance input from the second road agent indicating an agreement to execute a cooperation action thereby allowing execution of the desired action by the first road agent; and
transmitting a response output to the one or more connected devices, wherein the response output includes instructions to invoke the desired action.

13. The computer-implemented method of claim 12, wherein managing interactions between the first road agent and the second road agent based on the sensor data and the desired action further includes translating the sensor data and the invocation input into a format capable of being processed by the second road agent.

14. The computer-implemented method of claim 12, wherein the invocation input is a voice utterance from the first road agent, and wherein managing interactions between the first road agent and the second road agent based on the sensor data and the desired action further includes translating the voice utterance into a command signal to control the second road agent.

15. The computer-implemented method of claim 14, wherein the cooperation acceptance input is a vehicle message received from the second road agent, and transmitting the response output includes translating the vehicle message to a speech output instructing the first road agent to perform the desired action.

16. A non-transitory computer-readable medium comprising computer-executable program instructions, wherein when executed by one or more processors, the computer-executable program instructions configures the one or more processors to perform operations comprising:
receiving an invocation input including a desired action to be executed by a first road agent at a traffic junction;
receiving sensor data associated with the invocation input and the desired action;
translating human-readable medium to vehicle-readable medium in a back-and-forth manner between the first road agent and a second road agent to coordinate execution of the desired action;
receiving a cooperation acceptance input from the second road agent indicating an acceptance to coordinate execution of the desired action or a non-acceptance to coordinate execution of the desired action; and
transmitting a response output invoking the desired action based on the cooperation acceptance input.

17. The non-transitory computer-readable medium of claim 16, wherein the first road agent is a road user and the second road agent is a vehicle, and wherein the invocation input is a voice utterance from the road user.

18. The non-transitory computer-readable medium of claim 17, further including processing the voice utterance and the sensor data into a command signal having a vehicle-readable format with instructions to control the vehicle to execute a cooperation action, and transmitting the command signal to the vehicle to execute the cooperation action.

19. The non-transitory computer-readable medium of claim 18, further including determining a classification of the road user based on the sensor data.

20. The non-transitory computer-readable medium of claim 19, wherein the processing includes processing the voice utterance, the sensor data, and the classification of the road user into the command signal.
